(19) United States
(12) Patent Application Publication
(10) Pub. No.: US 2023/0043029 A1
(43) Pub. Date: Feb. 9, 2023

(54) CURRENCY CHANGE MANAGEMENT SYSTEM

(71) Applicant: Koinage Inc., Franklin, OH (US)

(72) Inventor: Chika Okere, Franklin, OH (US)

(73) Assignee: Koinage Inc., Franklin, OH (US)

(21) Appl. No.: 17/822,891

(22) Filed: Aug. 29, 2022

Related U.S. Application Data
(63) Continuation-in-part of application No. 16/741,103, filed on Jan. 13, 2020.
(60) Provisional application No. 62/792,013, filed on Jan. 14, 2019.

(51) Int. Cl. G06Q 20/38; G06Q 20/06; G06Q 20/36; G06Q 20/12; G06Q 20/20

(52) U.S. Cl. CPC G06Q 20/381; G06Q 20/0655; G06Q 20/3676; G06Q 20/12; G06Q 20/202; G06Q 20/26

(57) ABSTRACT

A network electronic device, method, and computer program product facilitate receiving, via a network interface and a network, transaction information originating from at least one of a merchant electronic system and a consumer electronic device associated with a hard currency transfer from a consumer to a merchant. In response to determining that the hard currency transfer is more than a full transaction amount, a controller of the network electronic device debits a merchant account balance in the digital currency accounting system associated with the merchant to correspond to an excess amount of the hard currency transfer. The controller credits a consumer account balance in the digital currency accounting system associated with the consumer to correspond to the excess amount of the hard currency transfer. The controller communicates an updated balance to at least one of the merchant electronic system and the consumer electronic device to conclude an associated transaction.

### CROSS-REFERENCE TO RELATED APPLICATIONS

The present application is a continuation-in-part of U.S. patent application Ser. No. 16/741,103 entitled “Currency Change Management System”, filed 13 Jan. 2020, which claims priority to U.S. Provisional Application No. 62/792,013, entitled “Currency Change Management System” filed 14 Jan. 2019, all of which are hereby expressly incorporated by reference herein for all purposes.

### FIELD OF THE INVENTION

The present disclosure generally relates consumer financial transactions and more particularly pertains to digital money management at a point of sale device.

### BACKGROUND OF THE INVENTION

Retail and other financial transactions are increasingly accomplished without use of traditional paper and coin currency i.e., tangible (“hard”). Digital credit and debit accounts are widely used to transfer funds from one electronic associated with a purchaser to another account associated with the seller or service provider. The accounts provide electronic records that facilitate tracking and auditing of transactions by particular persons, either corporate or human. Although such systems provide a great deal of productivity and efficiency, credit or debit-based transactions can jeopardize personal privacy. Legal transactions can be associated with social stigmas or divulge too much about a person that third parties should not have access to. Such person data is all too frequently disclosed inadvertently or maliciously to third parties, such as by entities that enable identity theft or fraudulent transactions.

For such considerations, use of cash currency is still a logical and traditional approach to effecting transactions. In addition, in some instances both of a consumer or a retailer are not in a position to use a credit or debit account, choosing to transact on a cash basis instead. Anonymity of the consumer is still possible by using currency. However, with inflation over time, the buying power of currency such as coins is reduced. In order to complete a transaction, a consumer and a point of sale (POS) system has to handle significant quantities of coins. Carrying and dispensing coins can be an inconvenience. It can be contemplated that with further inflation, small value paper currencies will similarly become inconvenient when making change.

### SUMMARY OF THE INVENTION

According to aspects of the present disclosure, an electronic system, method, and computer program product provide an enterprise solution for accumulation and transfer of KoinAge digital currency as part of a physical, tangible (“hard”) currency transaction between multiple merchants and multiple consumers. Although transactions increasingly happen wholly with digital (“soft”) financial transfers, use of hard currency still has a role for preserving personal privacy and enabling “offline” transactions that do not need communication equipment. The present disclosure minimizes or avoids conventional credit transaction fees while also avoiding the need for smaller denomination coins and bills. In an example, hard or tangible currency is paper bills and coins. In one or more embodiments, the method includes storing, in a memory, a digital currency accounting system that includes more than one monetary balance respectively for the more than one merchant and for the more than one consumer. the method includes receives, via a network interface and a network, transaction information originating from at least one of a merchant electronic system and a consumer electronic device associated with a hard currency transfer from a consumer to a merchant. In response to determining that the hard currency transfer is more than a full transaction amount, the method includes: (i) debiting a merchant account balance in the digital currency accounting system associated with the merchant to correspond to an excess amount of the hard currency transfer; (ii) crediting a consumer account balance in the digital currency accounting system associated with the consumer to correspond to the excess amount of the hard currency transfer; and (iii) communicating an updated balance to at least one of the merchant electronic system and the consumer electronic device to conclude an associated transaction for the full transaction amount. In response to determining that the hard currency transfer is less than the full transaction amount, the method includes: (i) crediting the merchant account balance associated with the merchant to correspond to a deficient amount of the hard currency transfer; (ii) debiting the consumer account balance associated with the consumer to correspond to the deficient amount of the hard currency transfer; and (iii) communicating an updated balance to at least one of the merchant electronic system and the consumer electronic device to conclude an associated transaction for the full transaction amount.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a functional block diagram of the communication environment connecting a network electronic system to consumer electronic devices, merchant electronic systems, and consumer electronic devices, according to one or more embodiments;

FIG. 2 is a diagram of a communication environment that facilitates a tangible (“hard”) currency transaction between a merchant and a consumer that minimizes or avoids conventional credit transaction fees while also avoiding the need for coins and small bills, according to one or more embodiments;

FIG. 3 is a front view illustrating an electronic device having a user interface presented on a touch screen display that can perform a consumer function, according to one or more embodiments;

FIG. 4 is a front view illustrating an electronic device having a user interface presented on a touch screen display that can perform a POS point of sale (POS) merchant function, according to one or more embodiments;

FIG. 5 is a timing diagram of a communication environment with a network electronic system facilitating digital currency transfer in conjunction with tangible (“hard”) currency transactions between a consumer electronic device and two merchant electronic systems, according to one or more embodiments;

FIGS. 6A-6B (collectively “FIG. 6”) are a flow diagram presenting a method performed by a network electronic device to facilitating digital currency transfer in conjunction with tangible (“hard”) currency transactions between a consumer electronic device and two merchant electronic systems, according to one or more embodiments; and

FIG. 7 is a flow diagram illustrating a method of combining tangible (“hard”) currency and digital money in a retail transaction, according to one or more embodiments.

### DETAILED DESCRIPTION

The present invention provides for a “KoinAge” system, which is a virtual coin manager that allows consumers to avoid carrying coins resulting from cash transaction. Merchants that provide goods and services can reduce the amount or number of coins and small bills that they need to procure to make change. Change is retained in a virtual piggy bank and accessed as needed via a mobile application. Problems addressed include: (i) avoiding discomfort in carrying large amount of coin; (ii) lack of purchasing power of coins in the US due to inflation; and (iii) discarding of coins that are perceived to have no value. (iv) coin shortages caused by inadequate circulation of coins in commerce.

Retailer(s) have a KoinAge API system integrated into point of sale (POS) systems. A POS cash transaction is entered into by an end user such as a customer or consumer having a KoinAge mobile application (app) at a retailer location having a POS system. In one or more embodiments, the cash transaction results in an amount of change that corresponds to coins amounting to less than paper currency that is on hand. In one or more embodiments, a POS system determines whether the consumer consents to receiving the change in form of a deposit to a KoinAge account used by the consumer. In one or more embodiments, the consumer consents to receiving the change by the KoinAge mobile application (app). In response to receiving or determining tacit or pre-existing consent, funds are immediately added and included in a balance of the KoinAge account when the merchant POS system transmits transaction details to the networked KoinAge Enterprise Application. Consumers can choose to keep this change in a virtual piggy bank from which they can make payments for other purchases using a mobile application. Additional payment acceptance systems include: (i) vending machines; (ii) tolls; and (iii) parking meters.

In collaboration with popular stores, the KoinAge system can be incorporated into existing payment systems. Consumers will be asked if the consumer would like to save or add their change to their KoinAge account. Once the consumer agrees, the payment system applies the change amount to the account of the customer by scanning the application on the mobile phone. The KoinAge payment system keeps a record of all transactions, balances, etc. The consumer is able to access funds as needed to pay for items approved for within the KoinAge payment system.

In one or more embodiments, a charitable donation can be made directly in lieu of the cash change due, or at least a portion of the change (e.g., that portion comprising low value coins). In one or more embodiments, a coupon code can be issued directly in lieu of the cash change due, or at least a portion of the change. A coupon code of may be redeemable for a product, a discount on a product, or for a discount on purchase of combination products. The coupon code may be of equal or greater value than the change to be received.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but no other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The description of the illustrative embodiments can be read in conjunction with the accompanying figures. Embodiments incorporating teachings of the present disclosure are shown and described with respect to the figures presented herein.

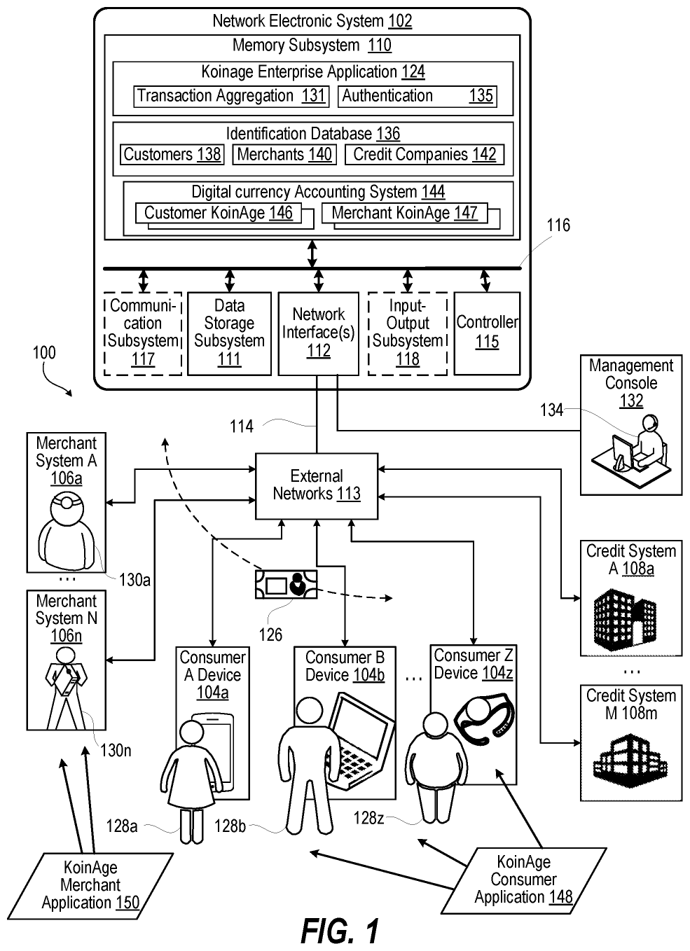

FIG. 1 is a functional block diagram of a communication environment 100 connecting a network electronic system 102 to consumer electronic devices 104a-104z, merchant electronic systems 106a-106n, and credit systems 108a-108m. Network electronic system 102 includes memory subsystem 110, data storage subsystem 111, one or more network interfaces 112 connected to external networks 113 via fiber 114 and managed by controller 115 via system interlink 116. In one or more embodiments, the network electronic system 102 is one or more network servers in a data center. In one or more embodiments, network electronic system 102 may further include other subsystems of a workstation or other user device. In an example, network electronic system 102 includes communication subsystem 117 and input-output subsystem 118 managed by controller 115 via system interlink 116.

Controller 115 executes applications stored in memory subsystem 110 to support accounting and network communication. In an example, KoinAge enterprise application 124, when executed by controller 115 supports aspects of the present disclosure by providing an enterprise solution for accumulation and transfer of KoinAge digital currency 126 as part of a hard currency transaction between combinations of consumers 128a-128z and merchants 130a-130n. In one or more embodiments, the KoinAge enterprise application 124 includes transaction aggregation component 131 that minimizes or avoids conventional credit transaction fees while also avoiding the need for coins and small bills to achieve a full transaction amount. In one or more embodiments, the network electronic system includes one or more servers that is managed and configured via a management console 132 by an operator 134. In one or more embodiments, the KoinAge enterprise application 124 includes an authentication component 135 that enables secure use of the communication environment 100 even when one of the parties to the transaction is not in communication with the network electronic system 102.

In one or more embodiments, the network electronic system 102 includes an identification database 136 that stores customer authentication information 138, merchant authentication information 140, and credit company authentication information 142. The network electronic system 102 includes a digital currency accounting system 144 that includes more than one monetary balance for the more than one consumer 128a-128z and for the more than one merchant 130a-130n, respectively customer KoinAge data 146 and merchant KoinAge data 147. In one or more embodiments, the KoinAge enterprise application 124, when executed by the controller 115, receives, via the network interface 112 and the external network 113, transaction information originating from at least one of a merchant electronic system 106a-106n and a consumer electronic device 104a-104z associated with a hard currency transfer from a consumer 128a-128z to a merchant 130a-130n. In response to determining that the hard currency transfer is more than a full transaction amount, the controller 115 debits a merchant account balance in the digital currency accounting system 144 associated with the merchant 130a-130n to correspond to an excess amount of the hard currency transfer. The controller 115 credits a consumer account balance in the digital currency accounting system 144 associated with the consumer 128a-128z to correspond to the excess amount of the hard currency transfer. The controller 115 communicates an updated balance to at least one of the merchant electronic system 106a-106n and the consumer electronic device 104a-104z to conclude an associated transaction for the full transaction amount.

In one or more embodiments, the consumer electronic devices 104-104z and the merchant systems 106a-106n include identical or similar components as described for the network electronic system 102 but executing respectively a KoinAge consumer application 148 and a KoinAge merchant application 150 that interact with the KoinAge enterprise application 124.

In one or more embodiments, an electronic device (102, 104a-104z, 106a-106n) having a communication subsystem 117 may support wireless communication capabilities to operate as a wireless communication device. Communication devices can be one of a host of different types of devices, including but not limited to, a mobile cellular phone or smart phone, a laptop, a netbook, an ultra-book, a networked smart watch or networked sports/exercise watch, and/or a tablet computing device or similar device that can include wireless communication functionality. As a device supporting wireless communication, a communication device can be one of, and also be referred to as, a system, device, subscriber unit, subscriber station, mobile station (MS), mobile, mobile device, remote station, remote terminal, user terminal, terminal, user agent, user device, cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. These various devices all provide and/or include the necessary hardware and software to support the various wireless or wired communication functions as part of a communication system. A communication device can also be an over-the-air link in a communication system that can be intended to be portable or hand-held or for which a user can move into close proximity. Examples of such communication devices include a wireless modem, an access point, a repeater, a wirelessly enabled kiosk or appliance, a femtocell, a small coverage area node, and a wireless sensor, etc. The communication subsystem 117 may support wireless communication over an antenna subsystem via a communication module. For example, the communication subsystem 117 may support communication protocols and transceiver radio frequencies appropriate for a wireless local area network (WLAN). The communication subsystem 117 can communicate over a personal access network (PAN) with devices such as a smart watch. The communication subsystem 117 may communicate with a radio access network (RAN) that is part of a wireless wide area network (WWAN). In certain embodiments, the communication subsystem 117 may also support a hardwired local access network (LAN) or peripheral devices via an I/O controller. The communication subsystem 117 may also communicate via near field communication (NFC) device to another electronic device.

In one or more embodiments, an electronic device (102, 104a-104z, 106a-106n) has a controller 115 that can be an integrated circuit (IC) that connects, via a plurality of bus interconnects, to a plurality of functional components of the electronic device. The controller 115 can include one or more programmable microprocessors, such as a processor, which may both be integrated into a single processing device, in some embodiments. the controller 115 controls the communication, user interface, and other functions and/or operations of the electronic device. These functions and/or operations thus include, but are not limited to including, application data processing and signal processing. The electronic device may use hardware component equivalents such as special purpose hardware, dedicated processors, general purpose computers, microprocessor-based computers, micro-controllers, optical computers, analog computers, dedicated processors and/or dedicated hard wired logic.

Connected to the controller 115 is the memory subsystem 110, which can include volatile memory and/or non-volatile memory. The memory subsystem 110 can include therein a plurality of modules, including firmware (F/W), UEFI BIOS platform, operating system (O/S) and application(s). The various software and/or firmware modules have varying functionality when their corresponding program code is executed by the controller 115 or other processing devices within the electronic device. The Unified Extensible Firmware Interface (UEFI) is a specification that defines a software interface between an operating system and platform firmware. UEFI is meant to replace the Basic Input/Output System (BIOS) firmware interface, present in a majority of conventional PC-compatible personal computers. In practice, most UEFI images provide legacy support for BIOS services. UEFI can support remote diagnostics and repair of computers, even without another operating system. The memory subsystem 110 may be augmented by on-device data storage subsystem 111 which may include a removable storage device (RSD) input/output (I/O) interface that receives an RSD for additional storage. An RSD as a computer readable storage device may be used to distribute and upload the KoinAge enterprise application 124, the KoinAge consumer application 148, and the KoinAge merchant application 150.

In one or more embodiments, an electronic device (102, 104a-104z, 106a-106n) having an input-output subsystem 118 may support interaction with a corresponding consumer 128a-128z or merchant 130a-130n. The input-output subsystem 118 may include input and output devices for enabling a user to interact and/or to interact with another electronic device. For example, an image capturing device, such as a camera, can receive displayed or printed identifiers in the form of alphanumeric codes, one-dimensional barcodes, and two-dimensional barcodes from printed substrate or a display of another electronic device. A microphone receives user audible inputs such as verbal passcode or unique response to a personalized question in lieu of, or in addition to, a visual authentication code. A user interface device can present visual or tactile outputs as well as receive user inputs. In one example, a user interface device can include a touch screen that is embedded within or associated with a display. An audio speaker can augment or provide alternate presentation of the visual or tactile outputs of user interface device. A tactile control can provide an interface such as for braille reading or manual inputs. A mobile printer can print identifiers in the form of alphanumeric codes, one-dimensional barcodes, and two-dimensional barcodes from printed substrate. The electronic device can be wholly or substantially encompassed by an enclosure as a unitary device. In one or more embodiments, the electronic device can be part of a distributed system of wireless or wired links or a component subsystem incorporated into a larger assembly or system.

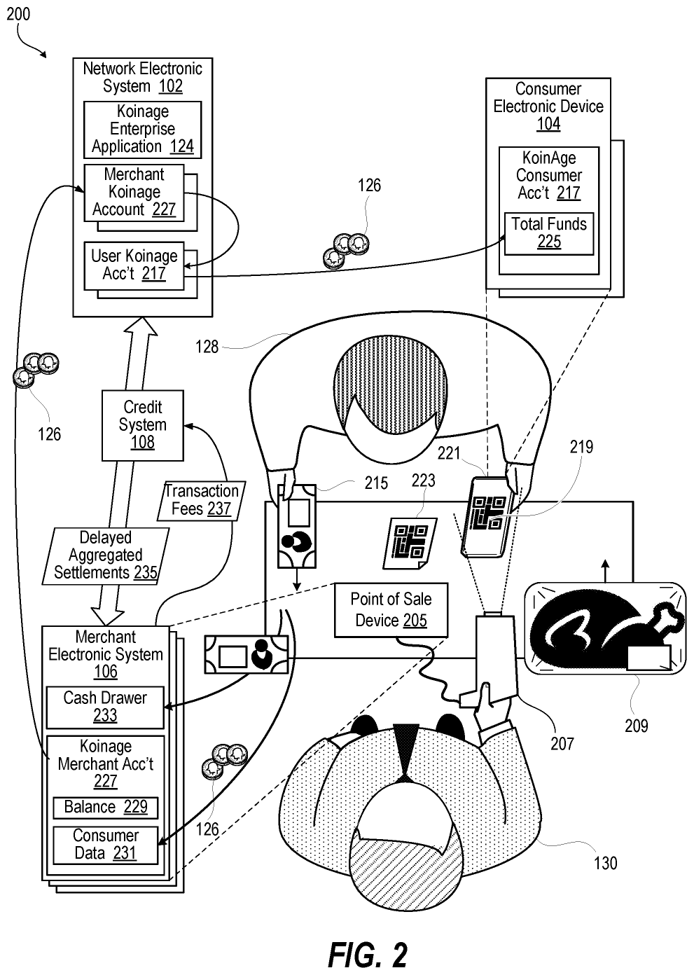

FIG. 2 is a diagram of a communication environment 200 in which the network electronic system 102 provides enterprise solution for accumulation and transfer of KoinAge digital currency 126 as part of a hard currency transaction between a merchant 130 and a consumer 128. In one or more embodiments, one of the parties such as the consumer 128 may not even be using their consumer electronic device 104 to conclude the transaction and the network electronic system 102 may not currently connected to a merchant electronic system 106. The merchant 130 uses the merchant electronic system 106 that includes a point-of-sale device 205 having an optical scanner 207. The consumer 128 purchases goods and services, depicted as a food product 209, using hard currency, such as large bill 215 that may be more than the purchase price of the food product 209. Merchant 130 authenticates access to a KoinAge consumer account 217 associated with the consumer 207 such as by scanning a unique optical code, depicted as a QR code 219 displayed on a consumer electronic device 221 or a printed copy 223. The network electronic system 102 has full privileges to manage the KoinAge user accounts 217 whereas the consumer electronic device 104 has client privileges to view a total funds balance 225. Similarly, the network electronic system 102 has full privileges to authenticate and manage KoinAge merchant accounts 227 whereas the merchant electronic systems 106 have client privileges to view a total funds field 229 available to the merchant 130 and to see at least confirmation that the consumer 128 is at least authenticated and perhaps to be able to inform the consumer 128 as to their respective balance in a respective consumer total funds balance 225 view at the merchant electronic system 106. The KoinAge merchant accounts 227 includes a real-time or batch consumer data transfer component 231. Merchant electronic system 106 can include other conventional features such as a cash drawer tracking component 233. In one or more embodiments, the merchant 130 can defer settling a deficit balance in the KoinAge merchant account 227, created delayed aggregated settlements 235 that are later handled by the credit system 108, which may incur a smaller aggregate transaction fee 237 than settling for each consumer transaction.

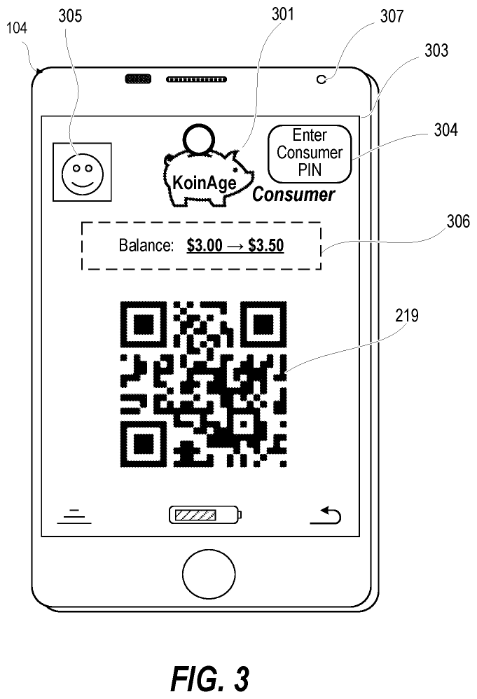

FIG. 3 is a front view illustrating a consumer electronic device 104 having a user interface 301 presented on a touch screen display 303 that can perform a consumer function. To fully enable the KoinAge consumer application 148 (FIG. 1), the consumer may enter a consumer personal identification number (PIN) 304 or other authentication code. Alternatively, the consumer may be recognized by facial authentication 305. In an example, a balance display 306 may only be visible when the consumer is detected to remain in front of a front camera 307 and disappear when the consumer electronic device 104 is turned for scanning of the QR code 219. In an example, an initial balance is $3.00. After providing a $10 bill for a $9.50 transaction, the balance changes to $3.50.

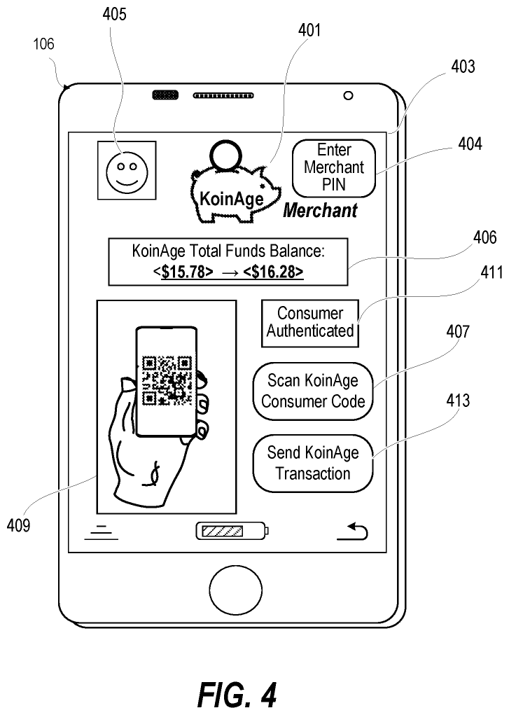

FIG. 4 is a front view illustrating a merchant electronic system 106 having a user interface 401 presented on a touch screen display 403 that can perform a POS point of sale (POS) merchant function. To fully enable the KoinAge merchant application 150 (FIG. 1), the merchant may enter a merchant PIN 404 or other authentication code. Alternatively, the merchant may be recognized by facial authentication 405. A balance display 406 informs the merchant of the size of an aggregate balance across multiple consumers and transactions since a last settlement has occurred. When a scan KoinAge consumer code control 407 is activated, a back camera captures an image stream of the consumer electronic device 104 that is presented on display window 409 in order to scan the QR code 219. A status window 411 indicates the progress in authenticating the consumer. In an example, an initial balance is $3.00. After receiving the $10 bill for a $9.50 transaction, the merchant sends the information via a send KoinAge transaction control 413, causing the balance to change from −$15.78 to −$16.28.

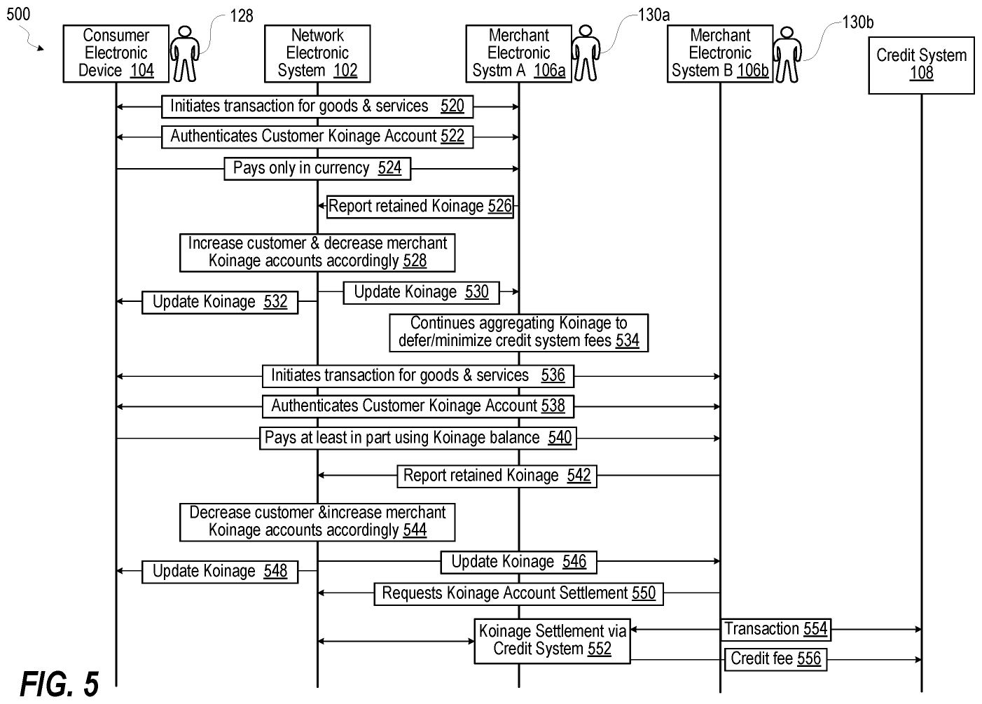

FIG. 5 is a timing diagram of a communication environment 500 with a network electronic system 102 facilitating digital currency transfer in conjunction with hard currency transactions between a consumer electronic device 104 and two merchant electronic systems 106a-106b with periodic financial settlements facilitated by a credit system 108. At 520, consumer 128 and merchant A 130a initiates a hard currency transaction via respectively the consumer electronic device 104 and the merchant electronic system 106a. At 522, the merchant electronic system 106a authenticates the consumer electronic device 104. At 524, the consumer 128 pays only in currency in an amount in excess of the purchase or invoiced amount and without drawing on any KoinAge digital currency balance. At 526, the merchant electronic system 106a reports the retained KoinAge digital currency (i.e., the change that was not physically returned to the consumer 128) to the network electronic system 102. At 528, the network electronic system 102 increases the customer account and decreases the merchant accounts accordingly (i.e., the currency retained by the merchant 130 is owed to the consumer 128). At 530, the network electronic system 102 communicates the updated the KoinAge merchant account balance to the merchant electronic system 106a. At 532, the network electronic system 102 communicates the updated the KoinAge consumer account balance to the consumer electronic device 104. At 534, merchant electronic system 106a continues to aggregate KoinAge digital currency transactions, deferring credit system fees.

At 536, consumer 128 and merchant B 130b initiates a hard currency transaction via respectively the consumer electronic device 104 and the merchant electronic system 106b. At 538, the merchant electronic system 106b authenticates the consumer electronic device 104. At 540, the consumer 128 pays at least in part by drawing on a KoinAge digital currency balance. In one or more embodiments, one of the network electronic system 102 and the merchant electronic system 106b may enable, and bear the risk for, allowing the consumer 128 to have a negative balance in KoinAge digital currency if the amount is insufficient. At 542, the merchant electronic system 106b reports the retained KoinAge digital currency (i.e., the change that was not physically returned to the consumer 128) to the network electronic system 102. In this instance, the merchant 130b has given more value than what the consumer 128 provided in hard currency, creating a negative retained KoinAge digital currency. At 544, the network electronic system 102 decreases the customer account and increases the merchant accounts accordingly (i.e., the merchant 130 is owed by the consumer 128). At 546, the network electronic system 102 communicates the updated the KoinAge merchant account balance to the merchant electronic system 106b. At 548, the network electronic system 102 communicates the updated the KoinAge consumer account balance to the consumer electronic device 104.

At 550, the merchant electronic system 106b requests settlement of the KoinAge merchant with the network electronic system 102. At 552, the network electronic system 102 handles the three-way transaction, having the credit system 108 handle the exchange of funds as appropriate between financial institutions associated with the network electronic system 102 and the merchant 130b. At 554, the credit system 108 communicates the exchange of transaction funds. At 556, the credit system 108 receives a credit fee that originates from the financial institution of the merchant 130b. The network electronic system 102 honors the increased KoinAge digital currency balance for the consumer 128 and defers transfer of actual money from the merchant 130a.

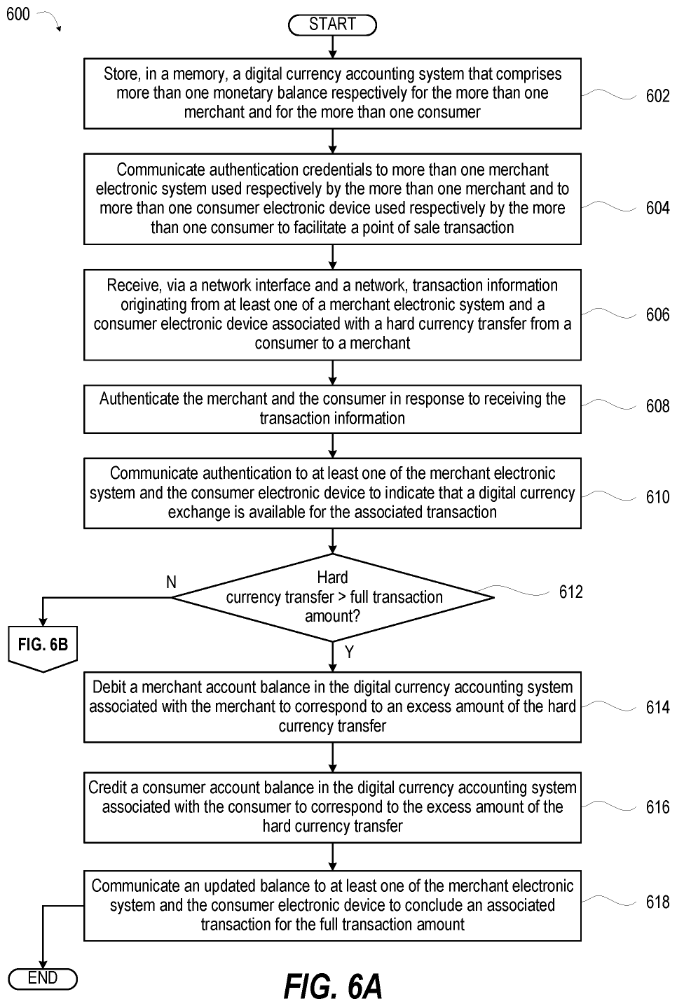

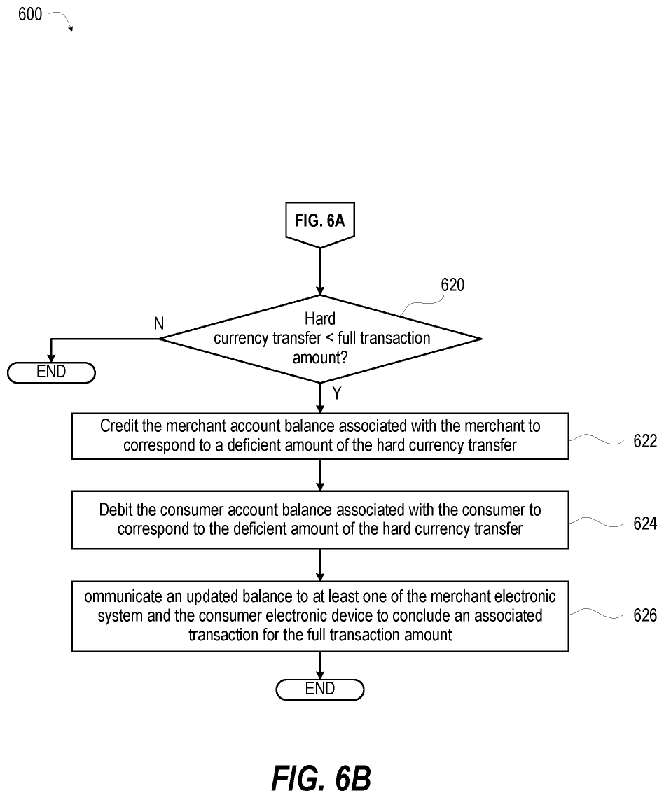

FIGS. 6A-6B (collectively “FIG. 6”) are a flow diagram presenting a method 600 performed by a network electronic device to facilitating digital currency transfer in conjunction with hard currency transactions between a consumer electronic device and two merchant electronic systems. With reference to FIG. 6A, the method 600 is performed by components of identical or functionally equivalent components described in FIGS. 1-5. In one or more embodiments, method 600 includes storing, in a memory, a digital currency accounting system that comprises more than one monetary balance respectively for the more than one merchant and for the more than one consumer (block 602). Method 600 includes communicating authentication credentials to more than one merchant electronic system used respectively by the more than one merchant and to more than one consumer electronic device used respectively by the more than one consumer to facilitate a point of sale transaction (block 604). In one or more embodiments, communicating the authentication credentials includes communicating a unique scan image to the consumer electronic device for displaying to a scan device of the merchant electronic system on one of a display screen and a hardcopy print copy.

Method 600 includes receiving, via a network interface and a network, transaction information originating from at least one of a merchant electronic system and a consumer electronic device associated with a hard currency transfer from a consumer to a merchant (block 606). In one or more embodiments, the authentication credentials enable the merchant to execute the transaction offline. In which case, method 600 includes receiving transaction information in batch when subsequently communicatively coupled to at least one of the merchant electronic system and the consumer electronic device. Alternatively, as depicted, method 600 may include participation by the network electronic device during the transaction. Method 600 includes authenticating the merchant and the consumer in response to receiving the transaction information (block 608). Method 600 includes communicating authentication to at least one of the merchant electronic system and the consumer electronic device to indicate that a digital currency exchange is available for the associated transaction (block 610).

Method 600 includes determining whether the hard currency transfer is more than a full transaction amount (decision block 612). In response to determining that the hard currency transfer is more than a full transaction amount, method 600 includes debiting a merchant account balance in the digital currency accounting system associated with the merchant to correspond to an excess amount of the hard currency transfer (block 614). Method 600 includes crediting a consumer account balance in the digital currency accounting system associated with the consumer to correspond to the excess amount of the hard currency transfer (block 616). Method 600 includes communicating an updated balance to at least one of the merchant electronic system and the consumer electronic device to conclude an associated transaction for the full transaction amount (block 618). Then method 600 ends.

In response to determining that the hard currency transfer is not more than a full transaction amount (i.e., equal to or less than) in decision block 612, method 600 includes determining whether the hard currency transfer is less than a full transaction amount (decision block 620). In response to determining that the hard currency transfer is not less than a full transaction amount (i.e., the hard currency transfer is equal to the full transaction amount, method 600 ends. In response to determining that the hard currency transfer is less than a full transaction amount, method 600 includes crediting the merchant account balance associated with the merchant to correspond to a deficient amount of the hard currency transfer (block 622). Method 600 includes debiting the consumer account balance associated with the consumer to correspond to the deficient amount of the hard currency transfer (block 624). Method 600 includes communicating an updated balance to at least one of the merchant electronic system and the consumer electronic device to conclude an associated transaction for the full transaction amount (block 626). Then method 600 ends.

In one or more, method 600 includes updating the more than one monetary balance in the digital currency accounting system respectively for the more than one merchant and for the more than one consumer across more than one transaction without requiring a financial credit settlement through a credit card system for each respective transaction to avoid or minimize transaction fees to the credit card system.

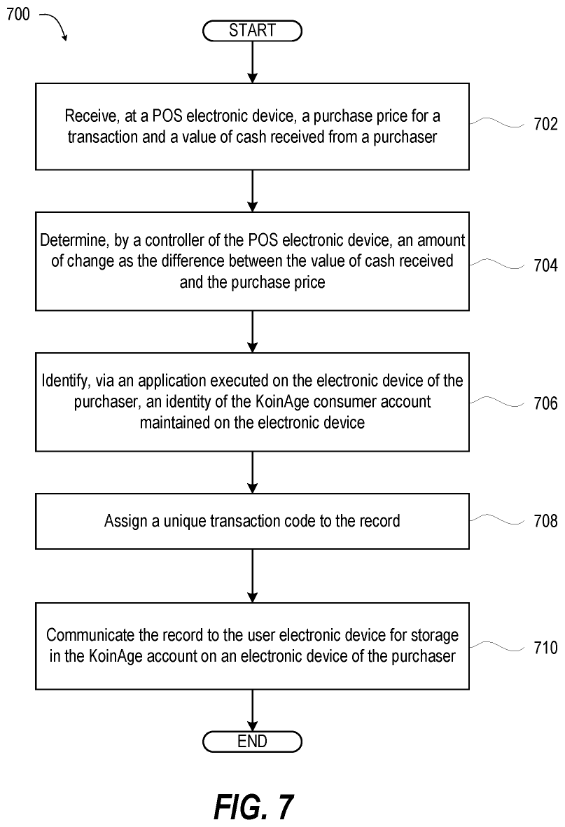

FIG. 7 is a flow diagram illustrating a method 700 of combining tangible (“hard”) currency and digital money in a retail transaction. In one or more embodiments, method 700 includes receiving, at a POS electronic device, a purchase price for a transaction and a value of cash received from a purchaser (block 702). Method 700 includes determining, by a controller of the POS electronic device, an amount of change as the difference between the value of cash received and the purchase price (block 704). Method 700 includes identifying, via an application executed on the electronic device of the purchaser, an identity of the KoinAge consumer account maintained on the electronic device (block 706).

In one or more embodiments, method 700 includes identifying the application executed on the electronic device comprises scanning an authenticating code generated by the electronic device on a selected one of: (i) a display of the electronic device comprising a mobile electronic device; and (ii) a printed substrate.

In one or more embodiments, method 700 includes identifying the application executed on the user electronic device comprises communicating with a selected one of: (i) a personal access network (PAN) interface; and (ii) near-field communication interface of the user electronic device.

Method 700 includes assigning a unique transaction code to the transaction record (block 708). Method 700 includes communicating the transaction record to the user electronic device for storage in the KoinAge consumer account on an electronic device of the purchaser (block 710).

In one or more embodiments, method 700 includes communicating with the user electronic device directly to provide the transaction record and the KoinAge consumer account. In one or more embodiments, method 700 includes communicating with the user electronic device indirectly by printing the record as a selected one of: (i) a one-dimensional bar code; (ii) a two-dimensional bar code; and (iii) an alphanumeric code for a purchaser to enter into the electronic device. Then method 700 ends.

With a positive balance in the KoinAge consumer account, method 700 can continue with a subsequent transaction that debits the KoinAge consumer account. For example, method 700 can include: (i) determining that the amount of change is a negative value; (ii) authenticating a balance in the KoinAge consumer account sufficient to cover the negative value based on authenticating one or more unique transaction codes; and (iii) creating the transaction record that debits the KoinAge consumer account to satisfy the negative value.

In one or more embodiments, method 700 includes receiving, at the POS electronic device, the purchase price for a transaction and the value of cash received from the purchaser comprises, by an automated currency counting machine. The automated currency counting machine receives currency, counts the currency, and identifies the purchase price as a fee for converting the currency into a consolidated form.

In the above-described flow charts of FIGS. 6A-6B and 7, the methods may be embodied in an automated control system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but no other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The description of the illustrative embodiments can be read in conjunction with the accompanying figures. Embodiments incorporating teachings of the present disclosure are shown and described with respect to the figures presented herein.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A network electronic device comprising:
a network interface connected to network;
a memory that stores a digital currency accounting system that comprises more than one monetary balance respectively for more than one merchant and for more than one consumer; and
a controller communicatively connected to the network interface and the memory, and which:
receives, via the network interface and the network, transaction information originating from at least one of a merchant electronic system and a consumer electronic device associated with a hard currency transfer from a consumer to a merchant;
in response to determining that the hard currency transfer is more than a full transaction amount:
debits a merchant account balance in the digital currency accounting system associated with the merchant to correspond to an excess amount of the hard currency transfer;
credits a consumer account balance in the digital currency accounting system associated with the consumer to correspond to the excess amount of the hard currency transfer; and
communicates an updated balance to at least one of the merchant electronic system and the consumer electronic device to conclude an associated transaction for the full transaction amount.

2. The network electronic device of claim 1, wherein the controller:
in response to determining that the hard currency transfer is less than the full transaction amount:
credits the merchant account balance associated with the merchant to correspond to a deficient amount of the hard currency transfer;
debits the consumer account balance associated with the consumer to correspond to the deficient amount of the hard currency transfer; and
communicates an updated balance to at least one of the merchant electronic system and the consumer electronic device to conclude an associated transaction for the full transaction amount.

3. The network electronic device of claim 2, wherein the controller updates the more than one monetary balance in the digital currency accounting system respectively for the more than one merchant and for the more than one consumer across more than one transaction without requiring a financial credit settlement through a credit card system for each respective transaction to avoid or minimize transaction fees to the credit card system.

4. The network electronic device of claim 1, wherein the controller communicates authentication credentials to more than one merchant electronic system used respectively by the more than one merchant and to more than one consumer electronic device used respectively by the more than one consumer to facilitate a point of sale transaction.

5. The network electronic device of claim 4, wherein, in communicating the authentication credentials, the controller communicates a unique scan image to the consumer electronic device for displaying to a scan device of the merchant electronic system on one of a display screen and a hardcopy print copy.

6. The network electronic device of claim 1, wherein the controller receives the transaction information in batch when subsequently communicatively coupled to at least one of the merchant electronic system and the consumer electronic device.

7. The network electronic device of claim 1, wherein the controller:
authenticates the merchant and the consumer in response to receiving the transaction information; and
communicates authentication to at least one of the merchant electronic system and the consumer electronic device to indicate that a digital currency exchange is available for the associated transaction.

8. A method comprising:
storing, in a memory, a digital currency accounting system that comprises more than one monetary balance respectively for more than one merchant and for more than one consumer;
receiving, via a network interface and a network, transaction information originating from at least one of a merchant electronic system and a consumer electronic device associated with a hard currency transfer from a consumer to a merchant;
in response to determining that the hard currency transfer is more than a full transaction amount:
debiting a merchant account balance in the digital currency accounting system associated with the merchant to correspond to an excess amount of the hard currency transfer;
crediting a consumer account balance in the digital currency accounting system associated with the consumer to correspond to the excess amount of the hard currency transfer; and
communicating an updated balance to at least one of the merchant electronic system and the consumer electronic device to conclude an associated transaction for the full transaction amount.

9. The method of claim 8, further comprising:
in response to determining that the hard currency transfer is less than the full transaction amount:
crediting the merchant account balance associated with the merchant to correspond to a deficient amount of the hard currency transfer;
debiting the consumer account balance associated with the consumer to correspond to the deficient amount of the hard currency transfer; and
communicating an updated balance to at least one of the merchant electronic system and the consumer electronic device to conclude an associated transaction for the full transaction amount.

10. The method of claim 8, further comprising updating the more than one monetary balance in the digital currency accounting system respectively for the more than one merchant and for the more than one consumer across more than one transaction without requiring a financial credit settlement through a credit card system for each respective transaction to avoid or minimize transaction fees to the credit card system.

11. The method of claim 8, further comprising communicating authentication credentials to more than one merchant electronic system used respectively by the more than one merchant and to more than one consumer electronic device used respectively by the more than one consumer to facilitate a point of sale transaction.

12. The method of claim 11, wherein communicating the authentication credentials comprises communicating a unique scan image to the consumer electronic device for displaying to a scan device of the merchant electronic system on one of a display screen and a hardcopy print copy.

13. The method of claim 8, further comprising receiving the transaction information in batch when subsequently communicatively coupled to at least one of the merchant electronic system and the consumer electronic device.

14. The method of claim 8, further comprising:
authenticating the merchant and the consumer in response to receiving the transaction information; and
communicating authentication to at least one of the merchant electronic system and the consumer electronic device to indicate that a digital currency exchange is available for the associated transaction.

15. A computer program product comprising:
a computer readable storage device; and
program code on the computer readable storage device that when executed by a processor associated with an electronic system, the program code enables the electronic system to provide functionality of:
storing, in a memory, a digital currency accounting system that comprises more than one monetary balance respectively for more than one merchant and for more than one consumer;
receiving, via a network interface and a network, transaction information originating from at least one of a merchant electronic system and a consumer electronic device associated with a hard currency transfer from a consumer to a merchant;
in response to determining that the hard currency transfer is more than a full transaction amount:
debiting a merchant account balance in the digital currency accounting system associated with the merchant to correspond to an excess amount of the hard currency transfer;
crediting a consumer account balance in the digital currency accounting system associated with the consumer to correspond to the excess amount of the hard currency transfer; and
communicating an updated balance to at least one of the merchant electronic system and the consumer electronic device to conclude an associated transaction for the full transaction amount.

16. The computer program product of claim 15, wherein the program code enables the electronic system to provide functionality of:
in response to determining that the hard currency transfer is less than the full transaction amount:
crediting the merchant account balance associated with the merchant to correspond to a deficient amount of the hard currency transfer;
debiting the consumer account balance associated with the consumer to correspond to the deficient amount of the hard currency transfer; and
communicating an updated balance to at least one of the merchant electronic system and the consumer electronic device to conclude an associated transaction for the full transaction amount.

17. The computer program product of claim 15, wherein the program code enables the electronic system to provide functionality of updating the more than one monetary balance in the digital currency accounting system respectively for the more than one merchant and for the more than one consumer across more than one transaction without requiring a financial credit settlement through a credit card system for each respective transaction to avoid or minimize transaction fees to the credit card system.

18. The computer program product of claim 17, wherein the program code enables the electronic system to provide functionality of communicating authentication credentials to more than one merchant electronic system used respectively by the more than one merchant and to more than one consumer electronic device used respectively by the more than one consumer to facilitate a point of sale transaction.

19. The computer program product of claim 18, wherein the program code enables the electronic system to provide functionality of communicating the authentication credentials by communicating a unique scan image to the consumer electronic device for displaying to a scan device of the merchant electronic system on one of a display screen and a hardcopy print copy.

20. The computer program product of claim 18, wherein the program code enables the electronic system to provide functionality of:
authenticating the merchant and the consumer in response to receiving the transaction information; and
communicating authentication to at least one of the merchant electronic system and the consumer electronic device to indicate that a digital currency exchange is available for the associated transaction.
